(19) United States
(12) Patent Application Publication
(10) Pub. No.: US 2026/0240085 A1
(43) Pub. Date: Aug. 20, 2026

(54) SYSTEM AND METHOD OF AGROCHEMICAL DELIVERY TO A LEAF USING ELECTROMAGNETIC RADIATION

(71) Applicant: Onteko Inc., Olive Branch, MS (US)

(72) Inventors: Luis Vidal Ponce Cabrera, Olive Branch, MS (US); Teresa Flores Reyes, Olive Branch, MS (US); Alejandro Ponce Flores, Byhalia, MS (US); Ernesto Ponce Flores, Sparks, NV (US)

(21) Appl. No.: 19/459,641

(22) Filed: Jan. 26, 2026

Related U.S. Application Data
(60) Provisional application No. 63/759,493, filed on Feb. 17, 2025.

(51) Int. Cl. A01G 7/04; A01G 24/44

(52) U.S. Cl. CPC A01G 7/045; A01G 24/44

(57) ABSTRACT

A method of applying agrochemicals directly to plants is provided. The method includes means to remove the waxy cuticle from a small area of the leaf of a plant, applying chemicals to the leaf at the point where the cuticle is removed, so as to directly apply medicants, fertilizers and other chemicals to the circulation system of the plant, without requiring the chemicals to penetrate the leaf's natural protective systems. The method further comprises the placement of a biodegradable patch on the leaf, after the application of the agrichemicals, so as to keep the chemicals in place while they are absorbed by the leaf and to protect the leaf from damage due to the removal of the waxy cuticle. The system provides for the use of handheld apparatus, robotic and gantry systems and via drone, to cover all manner and size of plants and fields.

### CROSS REFERENCE TO RELATED APPLICATIONS

This is a non-provisional Patent Application claiming priority from U.S. Provisional Patent No. 63/759,493, filed Feb. 17, 2025, which is hereby incorporated by reference in its entirety.

### FIELD OF THE INVENTION

The present invention relates generally to an agrochemical delivery system. More specifically, the present invention is an agrochemical delivery system wherein a plant cuticle is removed using electromagnetic radiation and a reservoir patch is applied over the prepared area to deliver said agrochemicals.

### BACKGROUND OF THE INVENTION

Modern agriculture relies heavily on the application of agrochemicals, including fertilizers, pesticides, and growth regulators, to maximize crop yield and maintain plant health. The most common method for agrochemical application is foliar spraying, in which the substances are distributed across the plant leaves in liquid form. However, this conventional approach presents significant inefficiencies and environmental challenges.

One of the primary obstacles in foliar agrochemical application is the presence of the leaf cuticle, a natural waxy barrier that serves as a protective layer for the plant. While essential for reducing water loss and protecting against environmental stressors, this waxy cuticle also inhibits the efficient absorption of externally applied agrochemicals. As a result, a substantial portion of the sprayed chemicals is lost, either running off the leaf surface or evaporating before absorption can occur. Studies indicate that up to 95% of agrochemicals applied through foliar spraying do not reach their intended target within the plant, leading to excessive usage and increased costs for farmers.

To compensate for this inefficiency, farmers must apply agrochemicals in large volumes, leading to significant economic and environmental consequences. The overuse of these chemicals not only increases operational costs but also contributes to potential phytotoxic effects, which can harm crop health rather than improve it. Moreover, the excess chemicals often seep into the surrounding ecosystem, contaminating soil, water bodies, and non-target plants, thereby posing a risk to biodiversity and human health.

In response to these challenges, several alternative methods for improving agrochemical absorption have been explored. One such method involves mechanically disrupting the leaf cuticle using sharp instruments, such as knives, to remove the wax layer before applying the chemical treatment. However, this approach is highly impractical for large-scale farming due to its labor-intensive nature and the risk of physically damaging the plant. Similarly, direct injection techniques, where agrochemicals are injected into plant tissues, have been investigated but suffer from similar drawbacks, including labor intensity, high costs, and potential interference with the plant's natural functions.

Despite these efforts, a highly efficient, scalable, and environmentally responsible solution to agrochemical application has remained elusive. Existing technologies fail to balance efficiency, cost-effectiveness, and sustainability, leaving farmers with limited options to optimize chemical use without harming their crops or the environment.

The present invention introduces a revolutionary two-step process that fundamentally transforms agrochemical application. The first step involves a precisely calibrated laser pulse that targets a small (approximately 5 mm) area of the leaf, selectively removing the waxy layer while ensuring that the underlying plant tissue remains undamaged. This preparatory step is critical, as it enables the efficient absorption of agrochemicals into the plant, overcoming the primary barrier that has long hindered foliar treatments.

Following the laser treatment, a specially designed biodegradable patch containing the necessary agrochemical is applied directly to the treated area. This ensures that the substance is absorbed efficiently, minimizing waste and maximizing effectiveness. The wax layer naturally regenerates shortly after, restoring the plant's protective barrier without requiring additional intervention.

Unlike traditional foliar spraying, this method ensures that agrochemicals are used with superior efficiency, significantly reducing the quantity required for effective treatment.

The application process is both rapid and scalable, with the instrument capable of treating one plant per second, making it feasible for large-scale agricultural operations. Additionally, the biodegradable patches naturally degrade, eliminating concerns regarding waste accumulation.

By integrating laser precision with targeted chemical application, the present invention not only eliminates agrochemical loss but also eradicates environmental contamination associated with excess chemical runoff. This breakthrough empowers farmers with a cost-effective, sustainable, and highly efficient solution, setting a new standard for responsible agricultural practices

### SUMMARY OF THE INVENTION

In accordance with the present invention, a method of focusing the delivery of agrochemicals to a plant, having leaves is provided. The method comprises the steps of exposing a small area of a plant leaf, having a waxy layer, to a calibrated pulse of light so as to selectively remove the waxy layer from the exposed area, while ensuring that the underlying plant tissue is undamaged. Then applying a biodegradable patch, containing a desired agrochemical directly to the exposed area for treatment. The pulse of light is laser light and has a light wave range of 405 nm to 532 nm laser. In a preferred embodiment, the pulse of light is at 450 nm blue diode laser, with a 1-5 W optical output.

The light of the disclosed method is applied to an area of a leaf of the plant of about a 0.1-5 mm² spot size. The spot can be made in patterns of spots, lines, grids or other patterns. The biodegradable patch of the invention comprises a patch composed of one of gel, hydrogel, membrane, microcapsule and confined liquids. The source of the calibrated pulse of light is from a light that is one of handheld, robotically transported, tractor-mounted and drone-mounted. The method includes the use of laser one of ultraviolet, visible light and infrared light waves.

Therefore, a preferred embodiment of the present invention includes a method of focusing the delivery of agrochemicals to a plant, having leaves, comprising the steps of exposing a small area of a plant leaf having a waxy layer, to a calibrated pulse of laser light, in the visual, ultra violet or infrared wavelengths, preferably between 405 nm and 532 nm with a 1-5 W optical output, to selectively remove the waxy layer from the exposed area of about 0.1-5 mm², while ensuring that the underlying plant tissue is undamaged, and applying a biodegradable patch, comprising one of gel, hydrogel, membrane, microcapsule and confined liquids, containing a desired agrochemical directly to the exposed area for treatment.

In addition to the summary of the invention, various parameters of the devices and method explained can be utilized without departing from the novel scope of the present invention. It will be seen that the method of the present invention uses specific laser parameters, in a preferred embodiment. In the preferred embodiment of the laser, with respect to laser type and wavelength, 450 nm blue diode laser, 1-5 W optical output is the preferred choice. It will be seen that in the alternative, the following are embodiments that can be employed:
808 NM IR DIODE LASER
405 nm blue diode laser
532 nm DPSS green laser
1064 nm pulsed Nd: YAG (consistent with earlier work)

With respect to emission mode, in the earlier patent applications filed, we focused on pulsed mode, in the present invention we have found that the system and method may operate in either Continuous-Wave (CW) mode or pulsed CW, if needed for thermal control.

With respect to the area of cuticle removal calibration, the combination of laser wavelength, power and scan speed is calibrated so that the wax cuticle is selectively removed without penetrating or damaging the epidermal tissue underneath.

In respect to the spot size of the light exposed on the leaves, the present invention allows for the spot to be adjustable, from about 0.1-20 mm², with a preferred working diameter 1-3 mm.

In the preferred embodiment, optical delivery is conducted with an adjustable collimator or fixed-focus lens. It will be understood that a collimated beam without focusing optics is also a simple and effective configuration that can be used as a substitute. Additionally, scanning mirrors may optionally be used for pattern generation, multi-spot coverage, or scale-up.

We have found that the best mode, which we show as the current protype for use to be as follows in the below description.

With respect to the light employed, a 450 nm handheld diode laser with 1-5 W optical power having 0.5-1 mm spot size and a 50 -150 ms application time or CW beam applied for equivalent duration

Moving now to the patch system described, in the preferred embodiment, the patch comprises three components:
1. Reservoir Layer, which contains the agrochemical in gel, hydrogel, membrane, micro-sponge, or simply liquid confined within a reservoir. Typical reservoir volume is 10-80 μL, depending on the crop and molecule.
2. Adhesive Layer, wherein the best mode adhesives include cellulose-based biodegradable adhesives, or plant-derived polysaccharides (e.g., pectin-based systems). With an adhesion time of about 12-72 hours, depending on the active ingredient.
3. Release Liner, which protects the adhesive prior to use and is removed at the moment of application.

Importantly, with respect to the biodegradation of the patch, all patch materials are designed to biodegrade naturally within 3-14 days, depending on environmental conditions. With respect to the agrochemical types, the patch reservoir may contain, among other elements, micronutrients (Zn, Mn, Fe, B, etc.), systemic pesticides (oxytetracycline, kasugamycin), plant hormones (GA₃, auxins) and peptides or other biological actives. This aligns with the “superior efficient application” principle described in the technical documentation.

The operational procedure (how the system works in practice) can be shown in the following steps:

Step 1—Laser Removal of the Wax Cuticle-the operator brings the device near the leaf, a CW or short-duration application removes a localized area of the cuticle (1-100 mm²). Wherein only the waxy layer is removed keeping the underlying tissue remains intact.

Step 2—Patch Application-the patch is pressed onto the freshly ablated area. The reservoir contacts the exposed epidermis directly, initiating immediate uptake.

Step 3—Absorption and Translocation-agrochemical uptake proceeds through apoplastic pathways, followed by vascular translocation (xylem or phloem depending on the molecule).

With respect to the timing of the activities of the best mode of the present invention; treatment time is approximately 1 second per plant (laser+patch); absorption time is approximately 2 -12 hours depending on the compound and full systemic translocation is about 24-72 hours or more, depending on the crop and the molecule.

In the preferred embodiment, the frequency of application is found to be, for perennials (e.g., citrus, avocado)—once per treatment cycle; for annuals (e.g., strawberry, lettuce)—once per production cycle. It will be understood that additional applications may be performed if agronomically required.

It is foreseen that certain environmental and operating conditions should be present during the operation of the best mode of the present invention. We have found that the method is functional under typical agricultural conditions. Moreover, the following conditions have been found to make the present invention particularly effective:
Temperature: 10-38° C.
Humidity: 20-95%
Usable day or night (daytime preferred for visibility)
Suitable for planting zones 8-11 (initial focus), but not restricted to specific crops or climates

Further, a current working system, in use, comprises a 450 nm, 5 W diode laser; continuous wave or equivalent duration application; cellulose-based biodegradable adhesive and reservoir containing Zn sulfate, oxytetracycline, or other relevant active ingredients.

In addition to the preferred embodiment, we have found the following, alternative embodiments of the invention to be particularly effective. Handheld Mode (best mode today)—human operator treats individual leaves. This is ideal for high-value crops (citrus, blueberry, avocado), floriculture, research greenhouses, and specialty crops. Semi-Automated Mode, wherein a robotic arm or gantry systems in greenhouse environments is used. Vision systems identify leaves and perform laser ablation+patch placement. Field-Scale Automated Systems, wherein, tractor-mounted units featuring scanning laser mirrors, automatic patch dispenser and leaf-targeting system are envisioned. Drone-Based Application, wherein drone-borne apparatus capable of laser delivery and patch placement in orchards or tall crops.

It will be understood that the present invention can include means providing for: near-100% uptake efficiency due to elimination of runoff, avoidance of pathogen entry because the opening is sealed by the patch; strong reduction in environmental contamination and significant reduction in the total agrochemical required per plant.

The present invention is fundamentally a two-step process (laser ablation+patch) which applies across the use of handheld devices (current best mode), semi-automated greenhouse systems and fully automated tractor-based or drone-based systems.

### BRIEF DESCRIPTION OF THE DRAWINGS

FIG. 1 is a flow diagram of the present invention.

FIG. 2 is a process diagram of the present invention.

FIG. 3 is a subprocess diagram of step 1 of the present invention,

FIG. 4 is a subprocess diagram of step 2 of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.) , simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

The present disclosure includes many aspects and features. Moreover, while many aspects and features relate to, and are described in the context of an agrochemical delivery system, embodiments of the present disclosure are not limited to use only in this context.

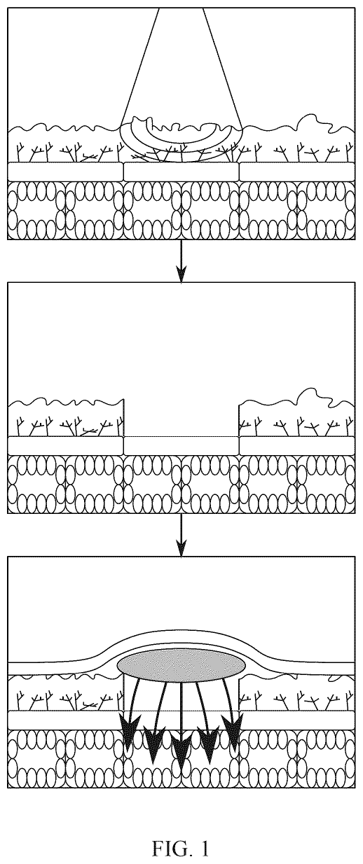

As shown in FIG. 1-4, the reference invention is an agrochemical delivery system comprising an emitter and a reservoir patch. In the context of the present invention, the emitter is a device that emits electromagnetic radiation, wherein said electromagnetic radiation is a laser. Additionally, within the context of the present invention, the emitter emits electromagnetic radiation onto a target area of a plant leaf such that the electromagnetic radiation prepares the plant leaf prior to application of the reservoir patch. In the preferred embodiment of the present invention, the laser is calibrated to only eliminate a waxy layer of the plant leaf referred to herein as “the cuticle”, without damaging the plant leaf. Following exposure to the electromagnetic radiation and removal of the cuticle of the targeted area of the plant leaf, the reservoir patch is applied to the targeted area, thus releasing agrochemicals into the plant leaf through the targeted area. In some embodiments of the present invention, the agrochemical delivery system treats one plant per second.

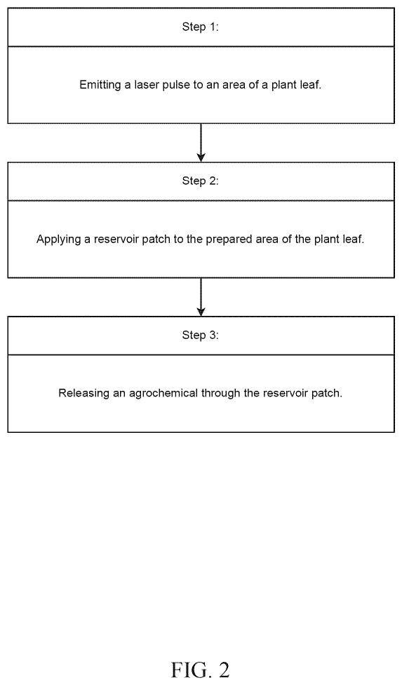

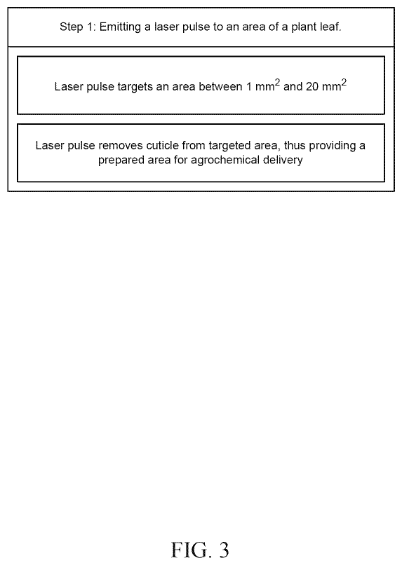

As shown in FIG. 2, in the preferred embodiment, the agrochemical delivery system comprises a method comprising the steps of emitting a laser pulse to an area of a plant leaf, applying a reservoir patch to the prepared are of the plant leaf, and releasing an agrochemical through a reservoir patch. As shown in FIG. 3, in the preferred embodiment of the present invention, the laser pulse, generated by the emitter, targets an area between 1 mm² and 20 mm². In some embodiments, the emitter comprises an adjustable optical collimator wherein said adjustable optical collimator adjustably controls the diameter of the target area produced by the laser pulse. Additionally, in the preferred embodiment of the present invention, the laser pulse removes the cuticle from the targeted area, thus preparing the area for agrochemical delivery.

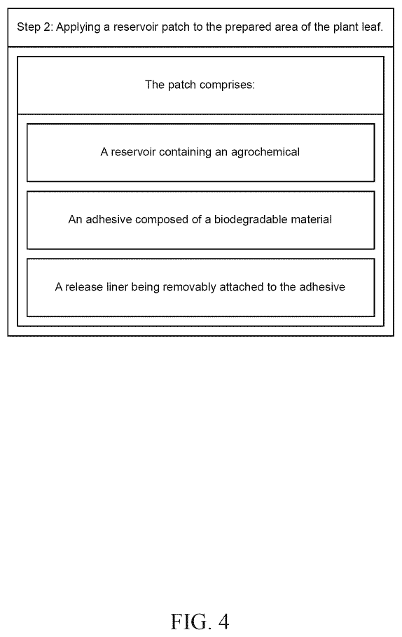

As shown in FIG. 4, in the preferred embodiment of the present invention, the reservoir patch comprises a reservoir and an adhesive. In the context of the present invention, the reservoir contains an agrochemical wherein said agrochemical is released from the reservoir upon application to a plant leaf. Moreover, in the context of the present invention, the adhesive secures the reservoir patch to the plant leaf. In the preferred embodiment of the present invention, the adhesive is composed of a biodegradable material. In some embodiments of the present invention, the reservoir patch further comprises a release liner, wherein said release liner is removably attached to the adhesive. In the context of the present invention, the release liner is removed from the adhesive prior to applying the reservoir patch to the plant leaf, thus exposing the adhesive.

Although the invention has been explained in relation to its preferred embodiment, it is to be understood that many other possible modifications and variations can be made without departing from the spirit and scope of the invention.

What is claimed:

1. A method of focusing the delivery of agrochemicals to a plant, having leaves, comprising the steps of:
exposing a small area of a plant leaf having a waxy layer, to a calibrated pulse of light to selectively remove the waxy layer from the exposed area, while ensuring that the underlying plant tissue is undamaged, and
applying a biodegradable patch, containing a desired agrochemical, directly to the exposed area, for treatment.

2. The method of claim 1, wherein the pulse of light is laser light.

3. The method of claim 2, wherein the pulse of light is light in the range of 405 nm to 532 nm laser.

4. The method of claim 1, wherein the pulse of light is at 450 nm blue diode laser with a 1-5 W optical output.

5. The method of claim 1, wherein the area of leaf to which the pulse of light is applied is a 0.1-5 mm² spot size.

6. The method of claim 1, wherein the biodegradable patch comprises one of gel, hydrogel, membrane, microcapsule and confined liquids.

7. The method of claim 1, wherein the source of the calibrated pulse of light is from a light that is one of handheld, robotically transported, tractor-mounted and drone-mounted.

8. The method of claim 1, wherein the area removed is removed in one or more of a pattern of spots, lines, grids, patterns.

9. The method of claim 2, wherein the laser is of one of UV, VIS and IR light.

10. A method of focusing the delivery of agrochemicals to a plant, having leaves, comprising the steps of:
exposing a small area of a plant leaf having a waxy layer, to a calibrated pulse of laser light, in the visual, ultraviolet or infrared wavelengths, preferably between 405 nm and 532 nm with a 1-5 W optical output, to selectively remove the waxy layer from the exposed area of about 0.1-5 mm², while ensuring that the underlying plant tissue is undamaged, and
applying a biodegradable patch, comprising one of gel, hydrogel, membrane, microcapsule and confined liquids, containing a desired agrochemical directly to the exposed area for treatment.

11. The method of claim 10, wherein the pulse of light is at 450 nm blue diode laser with a 1-5 W optical output.
